(19) United States
(12) Patent Application Publication
(10) Pub. No.: US 2013/0157648 A1
(43) Pub. Date: Jun. 20, 2013

(54) System and Method for Remotely Controlling An Animal Feeder

(71) Applicant: Alvin Henry Boenker, IV, Weatherford, TX (US)

(72) Inventor: Alvin Henry Boenker, IV, Weatherford, TX (US)

(73) Assignee: Quadzilla Performance Technologies Inc., Forth Worth, TX (US)

(21) Appl. No.: 13/527,294

(22) Filed: Jun. 19, 2012

Related U.S. Application Data
(60) Provisional application No. 61/505,193, filed on Jul. 7, 2011.

(51) Int. Cl. H04W 4/00

(52) U.S. Cl. CPC H04W 4/001
USPC 455/420

(57) ABSTRACT

A control system of a remotely-controlled device using a mobile telephone, the control system comprising a software application executing in the mobile telephone, the software application including a graphical user interface enabling a user to enter commands, the system includes a first wireless communication interface operable to communicate with a second wireless communication interface of the mobile telephone, a memory storing coded instructions, a processor operable to execute the coded instructions and receive timer setting commands from the mobile telephone, set at least one timer in response to the received timer setting commands, and control the remote controlled device according to the day, time, and duration settings of the at least one timer.

### RELATED APPLICATION

This application claims the benefit of U.S. Provisional Patent Application Ser. No. 61/505,193 filed on Jul. 7, 2011.

### FIELD

The present disclosure relates to a system and method for remotely controlling an animal feeder using a communication device such as a smartphone or another mobile device.

### BRIEF DESCRIPTION OF THE DRAWINGS

FIG. 1 is a simplified block diagram of an exemplary control system and method for remotely controlling an electro-mechanical device using a wireless mobile communication device such as a smartphone;

FIG. 2 a simplified diagram representation of an exemplary screen shot of a graphical user interface of a software application executing on the mobile device;

FIG. 3 a simplified diagram representation of another exemplary screen shot of a graphical user interface of a software application executing on the mobile device; and

FIG. 4 is a simplified diagram representation of yet another exemplary screen shot of a graphical user interface of a software application executing on the mobile device.

### DETAILED DESCRIPTION

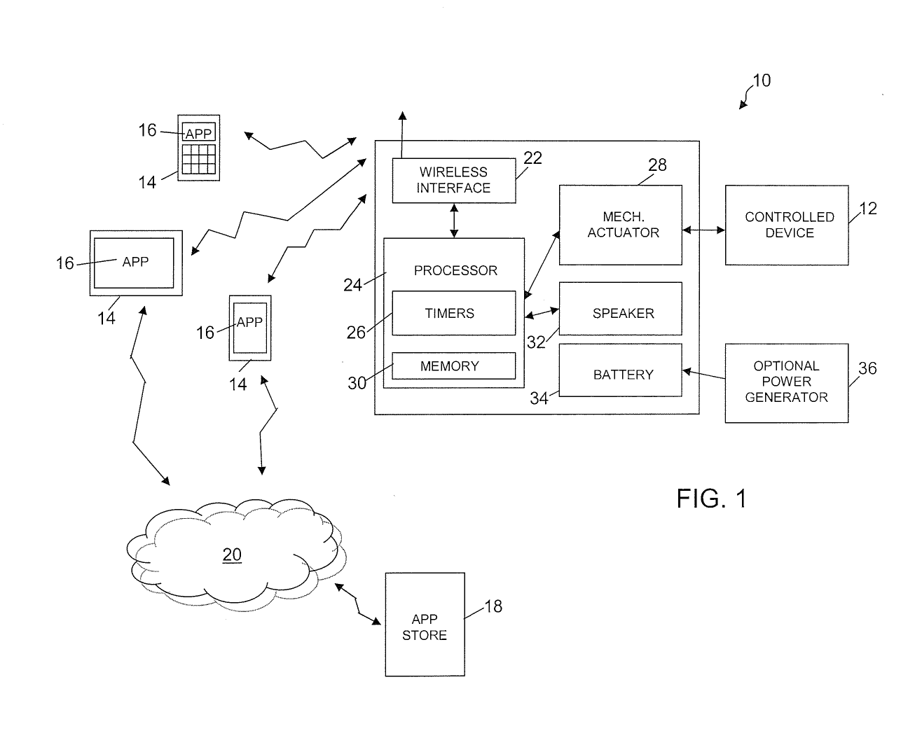

FIG. 1 is a simplified block diagram of an exemplary control system and method 10 for remotely controlling an existing electro-mechanical device (the controlled device) 12 using a mobile device 14 such as a mobile telephone (Apple iPhone, iTouch, and iPad devices, Kindle devices, Nook devices, and any BlackBerry, Android, Samsung, Nokia, HTC, Motorola, and like devices now known or later developed), laptop, tablet PC, and the like. The mobile device 14 is capable of downloading and executing software applications (apps) 16 from an app store 18 and over a global computer network 20 via the cellular mobile telephone network, a satellite network, etc. Alternatively, the app 16 may be downloaded to a personal computer or laptop (not shown) first and then transferred to the mobile device 14. The mobile device 14 is further equipped with a short-distance wireless communications interface now known or later developed such as WiFi, Bluetooth, infrared, etc. The system 10 is also equipped with a short-distance wireless communications interface 22 such as WiFi, Bluetooth, infrared, and the like for communicating with the mobile device 14. Alternatively, the system 10 may communicate and receive commands from the mobile device 14 via the cellular telephone network, satellite communication network, and global computer network, for example. It should be understood that suitable routers and relays may be incorporated in the communication path between the system 10 and mobile device 14 as needed. It should also be understood that the system and method 10 described herein may be adapted to incorporate any type of wireless communication method using any protocol now known or to be developed.

The system 10 includes a processor 24 that is operable to execute a plurality of coded instructions stored in memory. The processor 24 further includes a timer 26 in communication with the wireless interface 22 to control an electro-mechanical actuator 28 such as a motor, solenoid, and/or valve. Alternatively, the processor 24 is operable to generate an electrical signal that may be used to control or turn on/off a device, such to drive a loud speaker, to play pre-recorded varmint or game call. The processor 24 includes a suitable memory device 30 to store program code and/or log data. The system 10 also includes a speaker 32 coupled to the processor 24. A battery 34 and the like is used to provide electricity to the circuits and components of the system 10. An optional power generator 36 such as a solar panel may be included. If necessary, a small screen may be incorporated to display status and other information.

In operation, the system 10 may be used to control, via the app executing on the mobile device 14, a plurality of devices that are electro-mechanically actuated. For example, a sportsman's control system 10 may be operable to control devices such as game feeders, animal feeders, trap and skeet shooting machines, decoys with moving parts, etc. The app may be pre-programmed with a set of feeder time schedules ideally suited for attracting certain game, or for raising certain types of animals, for example. Many aspects of the electro-mechanical actuator may be controlled by the mobile device. For example, feed time, feed frequency, feed duration, etc. may be set and controlled using the software app. An exemplary list of data and control messages transmitted in ASCII format is set forth below:
Feed Time 1-10 with Days
Feed Duration for Times 1-10 (can be included with each feed time set message)
Instant On
Instant On Duration
Instant On Delay (test delay)
Battery Volts (6v or 12v) display
Battery Volts Backup
Last Feed Time
Number of Feeds since last cleared
Spin power 1-10
Time/Date
WIFI Config Mode info
WIFI Name Mode
# of Feeds Left on Battery
Factory Defaults Reset

The system 10 may also include appropriate controls and interfaces to remotely operate and control (On/Off, record, pan, zoom, etc.) video cameras and/or still photography cameras (either integrated with system 10 or stand-alone models), and play pre-recorded animal calls (On/Off, timed, volume control, etc.). The app executing on the mobile device 14 may be used to set and reset the timers at which times the electro-mechanical actuator is turned on and off or manipulated in a certain way, for example.

The control system 10 is preferably enclosed within a weather-tight enclosure for outdoor applications and may be installed to work with any device where remote control is desirable. All circuit components are also preferably rated to withstand outdoor temperatures.

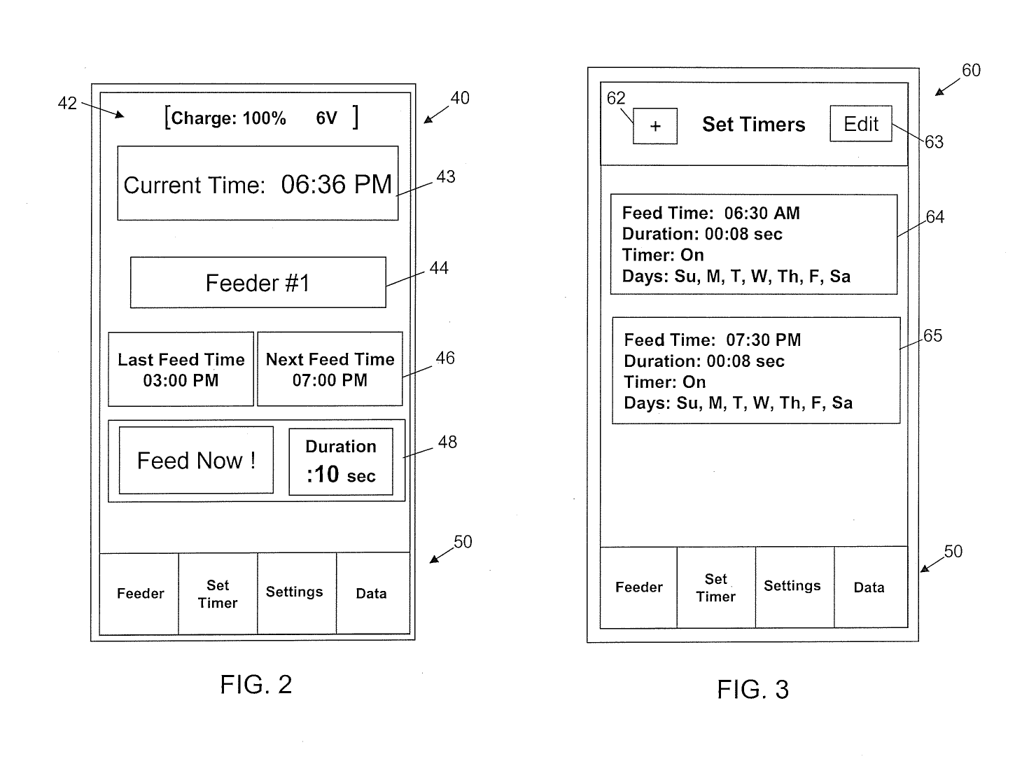

The description of FIGS. 2-4 below sets forth examples of typical applications of a control system, but the control system concept described herein should not be limited to these examples.

FIG. 2 is a simplified diagram representation of an exemplary screen shot of a graphical user interface of a software application 16 executing on the mobile device 14. In the examples, a touch screen implementation is contemplated although other user interfaces may be used. FIG. 2 shows an exemplary screen shot 40 for an animal or game feeder application. The screen may display the percentage charge in the available power for the system, and the voltage level the system is currently operating on 42. The current battery voltage or status may be displayed on the screen, and a warning may be incorporated if the battery's power has fallen below a certain level, for example. A warning display that indicates the number of feedings left that can be supported by the current battery power level could be incorporated. The screen further displays a current time 43. Preferably, the date and time of the system 10 are automatically in sync with the mobile device's date and time setting. Alternatively, the date and time of the system 10 may also be set via the graphical user interface of the app 16. As referenced at numeral 44, each control system may be assigned a unique name or identifier by the user to distinguish each control system from a plurality of control systems. FIG. 2 shows a screen shot for Feeder #1. The user may selectively communicate and control a particular control system by selecting the name or identifier of a control system. The user may further set each control system to become receptive on a schedule, such as every 5 minutes on the clock or 15 minutes, etc. So once set the user would be able to connect and communicate with each control system at these time intervals on the clock. Preferably, all setup may be done using the mobile device 14 and the app 16.

A feeder status 46 is also shown on the screen to indicate the last feeding time and the next scheduled feed time. As shown, a “Feed Now!” button 48 may be used to set off the feeder immediately for a user-defined or default time duration. This function is especially useful for testing the feeder setup. A time delay for testing or using this feature may be incorporated so that the user is able to leave the feeder area.

The graphical user interface also includes a menu 50 having a plurality of options to access other functions, including feeder, set timer, settings, and data, for example.

FIG. 3 is a simplified diagram representation of another exemplary screen shot 60 of a graphical user interface of a software application 16 executing on the mobile device 14. This screen 60 provides the user information about the current timer settings. This screen may be used to access the edit and add timer functions using buttons 62 and 63. As shown, the current feed time settings include two daily feedings 64 and 65, one at 6:30 AM, and a second one at 7:30 PM, for example.

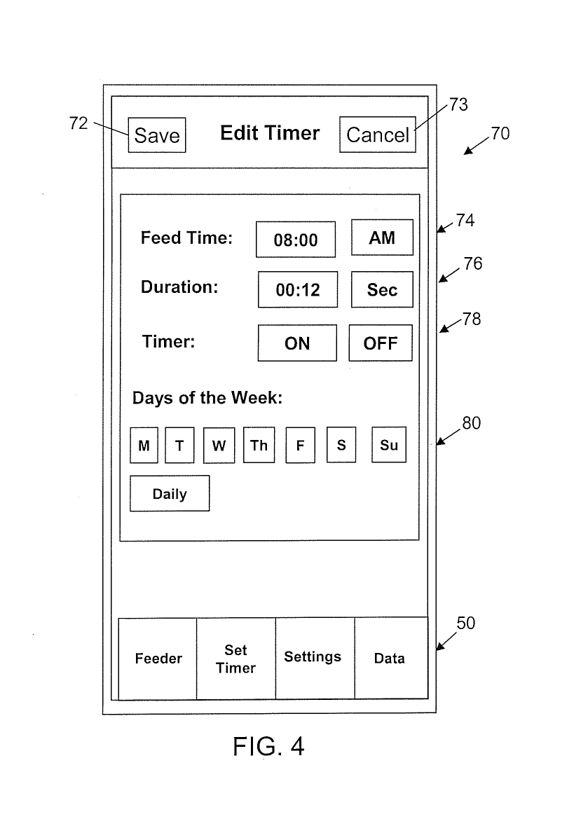

FIG. 4 is a simplified diagram representation of yet another exemplary screen shot 70 of a graphical user interface of a software application 16 executing on the mobile device 14. This screen 70 provides the user the ability to set or edit a timer. The buttons 72 and 73 are used to save and cancel the timer setting, respectively. The setting for the timer includes feed time, 74, feed duration 76, on/off 78, and days of the week 80.

The screen may also report feed time errors if the timer did not go off when it was scheduled to, such as when the battery power was too low. A backup battery may be automatically used to supply additional power for continued feeder operation and recording of feeder status, for example, when the main battery power drops below a certain level. A log may be recorded to maintain the feeder's operating status over a certain period of time and overwritten with newer status information. The processor is operable to receive operating parameter information from the electro-mechanical actuator that is then transmitted to the mobile device.

Another aspect of the feeder that may be controlled via the mobile device includes the spin rate of the feeder to control the range the feed is flung out. In some applications, a larger feed radius is desirable but in other applications, a more controlled and smaller feed pattern is desirable. Accordingly, the actuation of the motor may be pulsed or modulated and set by the mobile device app to control the spin rate.

Other functions include track the feed usage calculated based on the timer settings, and provide a calendar date for refilling the feeder.

The features of the present invention which are believed to be novel are set forth below with particularity in the appended claims. However, modifications, variations, and changes to the exemplary embodiments described above will be apparent to those skilled in the art, and the control system and method described herein thus encompass such modifications, variations, and changes and are not limited to the specific embodiments described herein.

What is claimed is:

1. A control system of a remotely-controlled device using a mobile telephone, the control system comprising:
a software application executing in the mobile telephone, the software application including a graphical user interface enabling a user to enter commands;
a first wireless communication interface operable to communicate with a second wireless communication interface of the mobile telephone;
a memory storing coded instructions;
a processor operable to execute the coded instructions and:
receive timer setting commands from the mobile telephone;
set at least one timer in response to the received timer setting commands; and
control the remote controlled device according to the day, time, and duration settings of the at least one timer.

2. The control system of claim 1, wherein the processor controls a remote controlled device selected from a group consisting of an animal feeder, a trap or skeet shooter, a decoy, a loud speaker, and a camera.

3. The control system of claim 1, wherein the processor is further operable to receive a command to immediately actuate the remotely-controlled device.

4. The control system of claim 1, wherein the processor is further operable to receive a command to immediately actuate the remotely-controlled device with a time delay set by the user.

5. The control system of claim 1, wherein the processor is operable to control an electro-mechanical actuator selected from the group consisting of a motor, a solenoid, and a valve.

6. A remote control system for controlling an electro-mechanical actuator coupled to an animal feeder using a mobile device, the remote control system comprising:
a first wireless communication interface operable to communicate with a second wireless communication interface in the mobile device;
a memory; and
a processor operable to:
receive a set timer command from the mobile device;
set timers in response to the received set timer command;
store timer settings in the memory; and
actuate the electro-mechanical actuator of the animal feeder to dispense animal feed in response to the timer settings.

7. The remote control system of claim 6, wherein the set timer command includes a specification of day, time, and duration for dispensing the animal feed.

8. The remote control system of claim 6, wherein the set timer command includes a command to immediately actuate the remotely-controlled device.

9. The remote control system of claim 6, wherein the set timer command includes a command to immediately actuate the remotely-controlled device with a predetermined time delay.

10. The remote control system of claim 6, wherein the set timer command includes a command to turn on and off a particular timer.

11. The remote control system of claim 6, wherein the processor is operable to transmit status information to the mobile device.

12. The remote control system of claim 6, wherein the first and second wireless communication interfaces are operable to communicate via at least one of cellular telephone network, satellite communication network, global computer network, WiFi, Bluetooth, and infrared.

13. The remote control system of claim 6, wherein the processor is operable to track animal feed usage and transmit usage status information to the mobile device.

14. A remote control system for controlling a controlled device using a mobile device, the remote control system comprising:
a wireless communication interface operable to communicate with the mobile device;
a memory; and
a processor operable to execute program instructions stored in the memory and:
receive set timer commands from the mobile device;
set at least one timer in response to the received set timer commands;
store timer settings in the memory;
actuate the controlled device at certain time, frequency, and duration in response to the timer settings;
logging operation status information in the memory; and
transmit operation status information to the mobile device in response to a status inquiry command received from the mobile device.

15. The remote control system of claim 14, wherein the processor is operable to actuate an electro-mechanical actuator coupled to an animal feeder.

16. The remote control system of claim 14, wherein the processor is operable to actuate a electro-mechanical actuator coupled to a hunting decoy.

17. The remote control system of claim 14, wherein the processor is operable to actuate a speaker coupled to the processor to play pre-recorded sounds.

18. The remote control system of claim 14, wherein the processor is operable to actuate a camera coupled to the processor to generate and store at least one image.
